(19) United States
(12) Patent Application Publication
(10) Pub. No.: US 2008/0212216 A1
(43) Pub. Date: Sep. 4, 2008

(54) Optical multipass cell for repeated passing of light through the same point

(76) Inventors: Milan Milosevic, Westport, CT (US); Violet Milosevic, Westport, CT (US)

Correspondence Address: Milan Milosevic, 9 Janson Drive, Westport, CT, 06880, US

(21) Appl. No.: 12/074,137

(22) Filed: Feb. 29, 2008

Related U.S. Application Data
(60) Provisional application No. 60/904,225, filed on Mar. 1, 2007.
(60) Provisional application No. 61/003,230, filed on Nov. 15, 2007.

(51) Int. Cl. G02B 5/08

(52) U.S. Cl. 359/850

(57) ABSTRACT

The present invention is a multipass unipoint optical cell used for the improved analysis of samples by transmission, reflection, Raman or fluorescence spectroscopy by the multiple reimaging of light through the same analysis point. The cell comprises two or more identical optical reimaging elements each consisting of two symmetrically opposing, identical, confocal, and coaxial parabolic reflective surfaces with the property to refocus any ray of light coming from the common focal point onto one of the parabolic surfaces, back to the same focal point by the other parabolic surface at an angle to the incoming ray. Two or more of these reimaging optical elements can be configured around the common focal point to form different multipass unipoint optical cell configurations, all the passes crossing in the analysis point where a sample is brought to interact with light, the effect of said interaction being enhanced in proportion to the number of passes.

### CROSS-REFERENCE TO RELATED APPLICATIONS

This application claims the benefit of provisional patent application Ser. No. 60/904,225, filed Mar. 1, 2007 by the present inventors and the benefit of provisional patent application Ser. No. 61/003,230, filed Nov. 15, 2007 by the present inventors.

### FEDERALLY SPONSORED RESEARCH

Not Applicable

### SEQUENCE LISTING OR PROGRAM

Not Applicable

### BACKGROUND

1. Field of the Invention

The field of the present invention relates to optical spectroscopy. Specifically, firstly it relates to the analysis of samples by Raman, transmission, reflection or fluorescence spectroscopy. Secondly, it relates to an optical multipass unipoint cell for the enhancement of said analysis by repeatedly reimaging the light back into the same analysis point. Thirdly, it relates to the special configuration of the reimaging system whereby the reflectance losses are recycled back for analysis thus improving the efficacy of the gain achieved by the multipass configuration.

2. Prior Art

In analyzing samples in spectroscopy, light is passed through an analysis point in which it interacts with the sample placed at that point causing either the absorption of said light or the emission of a secondary light (such as Raman, fluorescence, etc.) by the sample. Both, the degree to which the light is absorbed, and the intensity and spectral characteristics of the emitted secondary light are influenced by the nature of the sample present in the analysis point. In this way a sample can be identified, the composition of a mixture quantified, etc. In some cases the absorption of light or the secondary emitted light are too weak to be reliably measured. One way this was traditionally addressed was by passing light multiple times through the sample using so called multipass cells.

It is common in so called attenuated total reflection (ATR) spectroscopy [N. J. Harrick: Internal Reflection Spectroscopy, Harrick Scientific Corporation, Ossining N.Y., 1987.] to employ a multipass cell comprising an optical element that has two parallel surfaces through which light propagates by reflecting in a zigzag fashion between said surfaces. If an absorbing sample is pressed against one or both of the flat surfaces, the attenuation of light that occurs at a single reflection is magnified by the multiple reflections. Although the effect is thus magnified, in each of these multiple reflections light interacts with a different portion of the sample requiring a large quantity of the sample for analysis. This can be a problem in those cases where only a small amount of sample is available.

Another example of a multipass cell is the so called White cell [John U. White, “Long Optical Paths of Large Aperture”, J. Opt. Soc. Am, No. 32 (1942), pp 285-288] routinely used for the analysis of gases by transmission spectroscopy. Light enters the cell and is reflected between a special arrangement of three spherical mirrors a large number of times until it exits the cell. The absorption of light by the gas in the cell is enhanced by the extended path provided by the cell's optics. These cells work well for absorption spectroscopy, but cannot be used to study gasses by Raman or fluorescence spectroscopy. Each pass through the White cell is distinct from all the other passes and there is no crossing point that could be the source of secondary emissions enhanced by multiple passes of light through said crossing point.

In order to use multipass cells for Raman, fluorescence, etc. studies of gasses a unipoint multipass cell was introduced [R. A. Hill, A. J. Mulac and C. E. Hackett, Retroreflecting Multipass Cell for Raman Scattering, Appl. Opt. 16 (1977) 2004-2008] that provided that all the passes cross in a single point. This crossing point of light is also the analysis point of the cell. A sample placed in this point interacts with all the passes through the cell greatly enhancing secondary emissions from this point. The unipoint multipass operation was achieved by two sets of retro-mirrors accompanied by two lenses. The midpoint between the lenses was also a focal point for the two lenses. Collimated light was retro-reflected back to the cell by the retro reflectors and refocused into the focal point by the lenses. By slightly offsetting one of the retro reflectors, the returning light is slightly offset with respect to the incoming light thus enabling multiple passes. After a number of passes, light falls out of the aperture of one of the lenses and exits the cell. The light intensity of every returning pass is reduced by reflection losses in the retro reflectors and on the lenses. Thus, after a number of passes, the intensity of the returning light is weakened sufficiently to offset the benefit of multiple passes.

A variation of the multipass cell configuration was introduced [J. C. Robinson, M. Fink and A. Mihill, New Vapor Phase Spontaneous Raman Spectrometer, Rev. Sci. Instrum. 63 (1992), 3280-3284] that utilizes two crossing points so that all the passes cross in one or the other point. Each of the points can become the source of Raman, fluorescence, etc. emissions. This cell design was an improvement on the unipoint multipass cell [Hill et al.] since it used only two spherical mirrors and thus had reduced reflectance losses. While the reflectance losses are reduced, they still limit the number of passes that can be effectively utilized by the cell. Also, having two crossing points instead of one reduces the gain achieved due to multiple passes.

Another version of the unipoint multiple pass concept has been proposed by Harrick [N. J. Harrick: Internal Reflection Spectroscopy, Harrick Scientific Corporation, Ossining N.Y., 1987.] for the ATR analysis of samples. This concept, however, was never reduced to practice because the shape of the ATR crystal required for the operation was too complex to manufacture and the optical design was not suitable for the reimaging of a typical spectrometer beam. However, it was recognized that if such a unipoint multipass cell could be developed, that it would be of great utility in ATR spectroscopy.

There is a need to further reduce reflectance losses in multiple pass cells so that a larger number of passes can be employed. Special coatings can be applied to optical surfaces either to enhance the reflectance of the reflecting surfaces or to suppress it for the transmitting surfaces. However, this can only be achieved in a limited spectral range and only for one polarization of the reflecting light.

### SUMMARY

The present invention is a multipass unipoint optical cell used for the improved analysis of samples by transmission, reflection, Raman or fluorescence spectroscopy by the multiple re-imaging of light through the same analysis point. The cell comprises two or more identical optical reimaging elements. A reimaging element incorporates a pair of symmetrically opposing confocal coaxial parabolic reflective surfaces that refocus the light exiting the point of analysis back into the same point of analysis at an angle with respect to the incident light, a second optical reimaging element that collects the light exiting said analysis point and refocuses it back to said analysis point, and so on multiple times, each pass at an angle to the previous.

The configuration of the cell can be either for transmission in which case light passes through the analysis point without changing the direction of travel, or it could be in reflection in which case light reflects from the sample in the analysis point. At each pass light is either slightly absorbed by the sample, or it excites the sample in the analysis point to emit radiation such as fluorescence or Raman radiation. Since light is brought into repeated interaction with the sample in the analysis point, the effect of the interaction of said light with said sample is enhanced in proportion to the number of passes. Either light exiting the cell after multiple passes, or the secondary radiation such as Raman or fluorescence emitted by the sample in response to the light passing through the cell multiple times, are analyzed by a spectrometer providing detailed analytical information about the sample.

### DRAWINGS—FIGURES

The unipoint multipass concept disclosed herein is based on an optical reimaging element consisting of two opposing confocal coaxial parabolic reflective surfaces 3 and 3′ illustrated in FIG. 1. Focal point 1 is common to both parabolic surfaces. A ray 2 coming from the focal point anywhere onto reflecting surface 3 is reflected to surface 3′ and refocused as ray 4 back to the focal point 1.

FIG. 2 shows a unipoint multipass transmission configuration achieved by using two opposing reimaging elements 6 and 7 arranged around the common focal point 8. Reimaging element 6 is slightly rotated around the common focal point 8 to enable the multipass configuration.

FIG. 3 illustrates how multiple reimaging elements can be arranged to enable a unipoint multipass configuration. Each reimaging element contributes a single pass.

FIG. 4 shows how the reimaging element of the present invention can be made out of an optically transparent material. The reflections occurring on the parabolic surfaces 11 and 12 are total internal reflections, while the front surface 13 has a spherical shape with the center of curvature at the common focal point 14. In this way light reflected by the front surface 13 is not lost to the measurement, but is reimaged back to the focal point 14. This is of a particular importance when the multipass unipoint configuration is used to excite Raman scattering or other types of secondary radiation.

FIG. 5 shows a unipoint multipass configuration that can be used to enhance the sensitivity of both reflectance and ATR spectroscopy. The reflecting element 15 placed in a common focal point is either a reflecting sample or a hemispherical ATR element. Several reimaging elements 16 are arranged around the hemisphere with their focal points 17 coincident with the center of curvature of the hemisphere. All the reimaging elements are arranged in a conical configuration around the hemisphere 15 and the common focus 17 is the apex of the cone.

FIG. 6 shows the side view of the ATR element 15. Light is incident into the center 17 of the hemispherical ATR element from a curved side of the hemisphere at an angle of incidence appropriate for internal reflection. After reflection on the flat face of the hemisphere, the light exits said hemisphere and is, by an reimaging element, refocused again back to the center 17. This is repeated several times by the other reimaging elements to magnify the effect of a single reflection. The exiting light is subsequently spectrally analyzed.

FIG. 7 shows a unipoint multipass configuration that can be used to enhance Raman or other secondary radiation emitted by a sample placed in the center of the hemisphere. This secondary radiation is excited by the excitation light undergoing multiple total internal reflections. The exitation light is brought into the center of a hemispherical optical element for internal reflection. Reflected light is captured and refocused back to the center of the hemisphere by the reimaging elements arranged in a conical configuration around the hemisphere. Secondary radiation 18 excited by the multiple internally reflected light is collected and spectrally analyzed.

### DRAWINGS—REFERENCE NUMERALS

1 Focal point of a reimaging element
2 Incoming ray
3 First parabolic mirror
3′ Second parabolic mirror
4 Outgoing ray
5 Axis of the two parabolic surfaces
6 First optical reimaging element
7 Second optical reimaging element
8 Focal point of two reimaging element multipass configuration
9 Outgoing ray
10 Incoming ray
11 First reflective parabolic surface
12 Second reflective parabolic surface
13 Spherical entrance/exit surface
14 Focal point of solid reimaging element
15 Hemispherical ATR element
16 Reimaging optical elements
17 Center of hemispherical ATR element
18 Outgoing secondary emitted radiation
20 Cutting plane for parabolic mirrors

### DETAILED DESCRIPTION OF THE PREFERRED EMBODIMENTS

The optical multipass unipoint cell configurations described herein are based on the special optical property of the optical reimaging element, consisting of two symmetrically opposing, identical, confocal, and coaxial parabolic reflective surfaces, to refocus any ray of light coming from the common focal point onto one of said surfaces, back to said focal point by the other surface.

One way in which this optical reimaging element can be made is by assembling together a pair of identical parabolic mirrors 3 and 3′ as shown in FIG. 1. An off axis parabolic mirror is made by one of the standard techniques such as diamond turning.

The flat surface 20 is then cut into the mirror through the focal point 1 and perpendicular to the axis of the parabola 5. Two such identical mirrors 3 and 3′ are then turned face to face in a mirror image fashion and joined together on said cut surfaces 20. The two parabolic surfaces thus arranged have a common axis 5 and a common focal point 1. This arrangement of two parabolic mirrors has the property that any light ray 2 coming from the common focal point 1 anywhere onto the entrance mirror 3 is reflected toward exit mirror 3′ parallel to the common axis and then reflected back into the focal point 1 by the exit mirror 3′. The returned ray 4 is at an angle with the incoming ray 2. Since this property of the mirror pair is true for any ray coming from the focal point to mirror 3, it is also true for a beam of light diverging from the focal point 1. Such a beam following ray 2 in reflecting at mirror 3 will be collimated after reflection from mirror 3. All the rays in the collimated beam will be parallel to the axis of the two parabolas and will be refocused by mirror 3′ back into the focal point 1. The light exiting a mirror pair can become the entering beam for another mirror pair confocal with the first mirror pair.

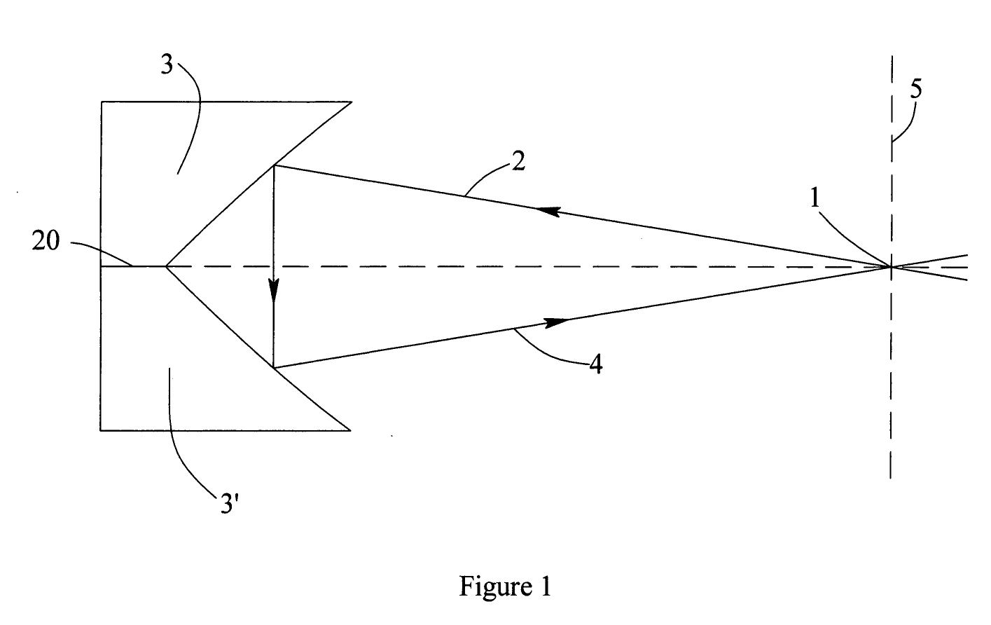

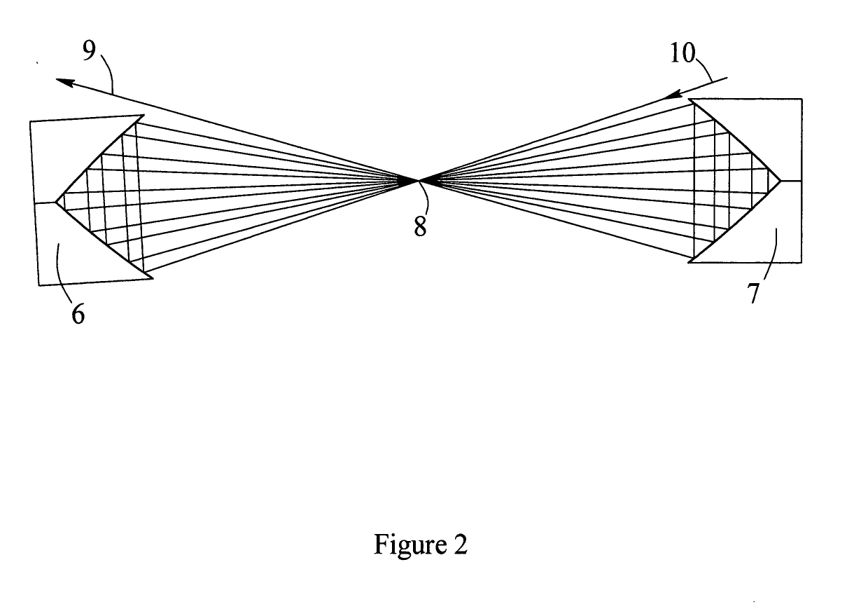

FIG. 2 shows a multipass unipoint optical cell made with two optical reimaging elements 6 and 7 arranged around the common focal point 8. The reimaging element 6 is slightly rotated around the focal point 8. As a result, the incoming ray 10 is engaged in multiple reflections between the two optical reimaging elements—all passing through the common focal point 8 until, after a number of passes, it escapes out as ray 9. The exact pattern of the reflections and the number of passes through the focal point 8 depend on the exact angle of rotation of the optical reimaging element 6. A different rotation angle produces a different reflection pattern and a different number of passes. Since these optical reimaging elements must accommodate multiple reflections of the beam, they necessarily have to be significantly larger than the cross section of the optical beam used.

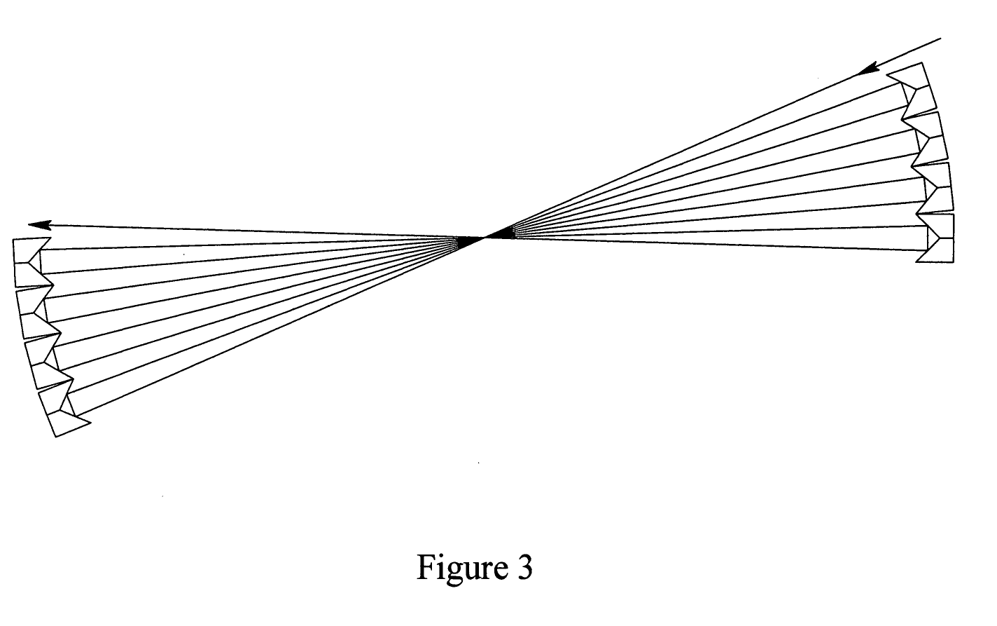

A different arrangement of the optical reimaging elements that can be used to achieve a unipoint multipass configuration is shown in FIG. 3. Instead of using two large optical reimaging elements, each accommodating multiple passes of the beam, it uses a number of small optical reimaging elements each just large enough to accommodate a single pass. These optical reimaging elements are positioned around the common focal point. Each, except for the first, is positioned to receive the beam exiting the previous optical reimaging element and refocus it back into the center and so on for multiple passes. Each optical reimaging element provides a single pass through the common focal point. The multipass unipoint optical cells shown in FIGS. 2 and 3 represent a considerable improvement over the prior art multipass unipoint cell since the number of optical elements is reduced in half. This simplifies the cell construction and alignment and significantly reduces the reflection losses.

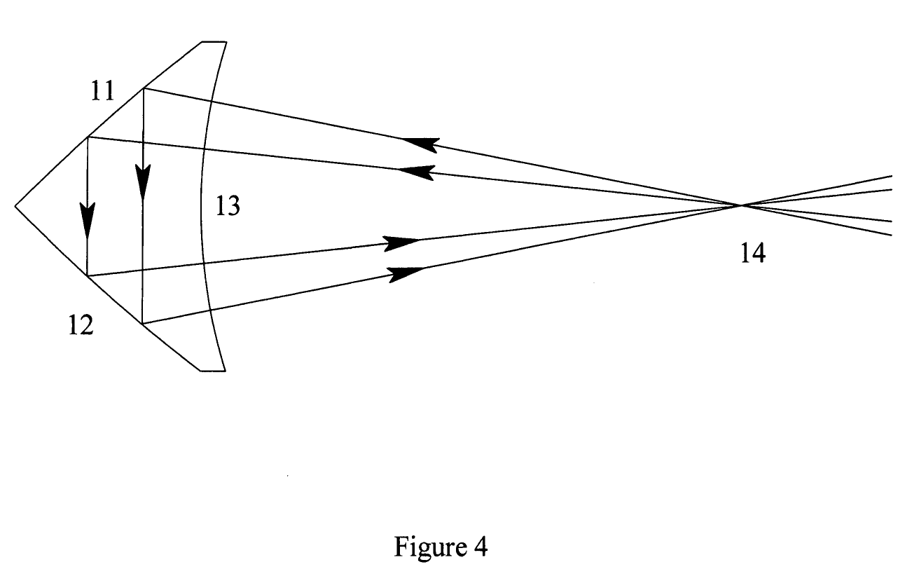

If the multipass unipoint optical cell configurations of the present invention are used for the excitation of Raman, fluorescence, etc. by a laser beam undergoing the multiple passes; it is possible to make the optical reimaging element in such a way to eliminate the negative effects of reflection losses for a broad wavelength range and both polarizations of laser light. Such an optical reimaging element is shown in FIG. 4. The internally reflecting parabolic surfaces 11 and 12 are cut into a piece of transparent material. In this way the reflections occurring at the parabolic surfaces 11 and 12 are not regular mirror reflections, which are never lossless, but total internal reflections, which are lossless for any wavelength and polarization of incident light. Point 14 is the common focal point of the two parabolic surfaces. The rays of light coming from the focal point to the reflecting surface 11 have to enter into the transparent material through surface 13. Instead of incurring reflection losses on the parabolic surfaces 11 and 12, this approach leads to reflection losses at the front surface 13 of the solid optical reimaging element. Surface 13 is cut in a spherical shape with the center of curvature coincident with the common focal point 14 of the two parabolic surfaces. Light coming from the focal point 14 is incident perpendicular on the front surface 13 and is split into two components, one transmitted into the solid optical reimaging element and one reflected and refocused back by the action of the spherical surface 13 into the focal point 14. The transmitted component proceeds through the solid optical reimaging element and is refocused back to focal point 14 by the action of the parabolic surfaces 11 and 12. Thus both reflected and transmitted light return back to the focal point 14 and no light energy is lost in the solid optical reimaging element.

If, for instance, laser light is used to excite secondary emissions by the sample, both transmitted and reflected components of the laser light will contribute to the excitement of these secondary emissions. So the special way in which the solid optical reimaging element is made out of a transparent material has for a consequence that the solid optical reimaging element recycles the reflection losses of laser light passing through the element back into the measurement regardless of the wavelength or the polarization of the laser light and in effect eliminates reflection losses.

FIG. 3 shows a unipoint multipass arrangement all contained in one plane. It is however possible to arrange optical reimaging elements around the common focal point in more elaborate ways. In assembling such an arrangement by adding the next optical reimaging element, one is free to rotate the optical reimaging element around the central ray connecting the common focal point and the entrance side of the optical reimaging element. That brings the exit side of the optical reimaging element out of the plane. Each additional optical reimaging element is similarly free to rotate around the central ray coming from the common focal point into the entrance side of said element, so the final configuration can be quite complicated.

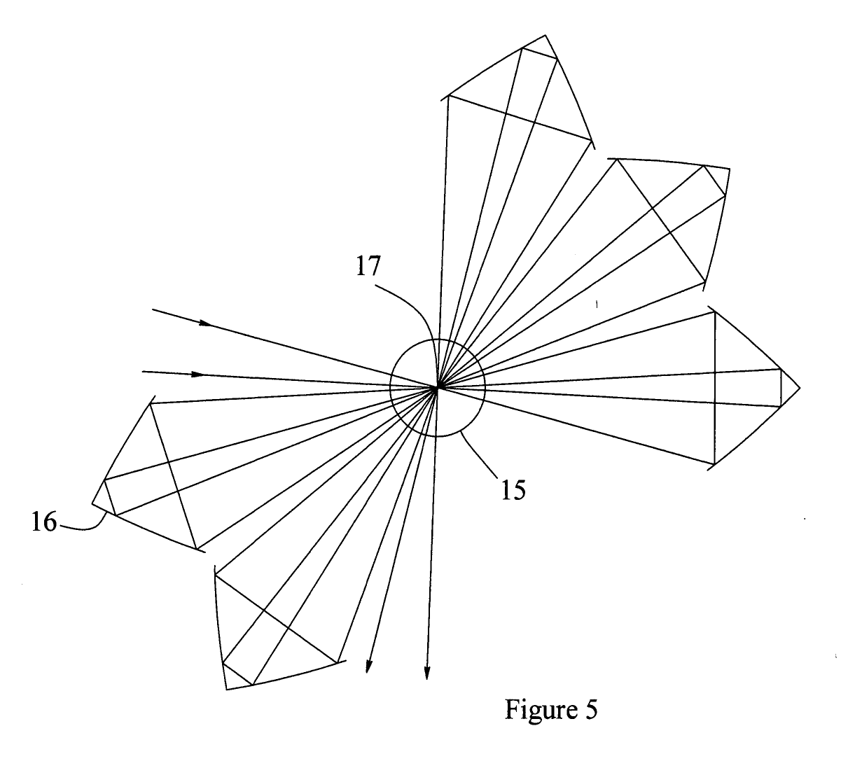

An assembly consisting of optical reimaging elements arranged in a conical configuration around the common focal point, shown in FIG. 5, can be used for unipoint multipass reflection spectroscopy. The optical reimaging elements can be either solid elements constructed in the manner shown in FIG. 4 or pairs of two individual parabolic mirrors put together in the manner shown in FIG. 1. A reflecting element is placed in the common focal point at the apex of the cone perpendicular to the cone's axis. This reflecting element can be either a reflecting sample, or a hemispherical ATR element.

If the reflecting sample at the apex of the cone is a metal mirror coated with a very thin film of absorbing material, the film would absorb a miniscule amount of light so that, with a single reflection, it would be very difficult to measure the amount of light absorbed. However, if the above described multipass unipoint cell is used to reflect light multiple times from the surface of the sample, the weak absorbing effect of the thin film is magnified as a function of the number of reflections. By greatly magnifying the effect of thin film absorption, very thin films can now be analyzed by non-contact means. And since all the reflections occur at the same point, the analysis spot can be very small.

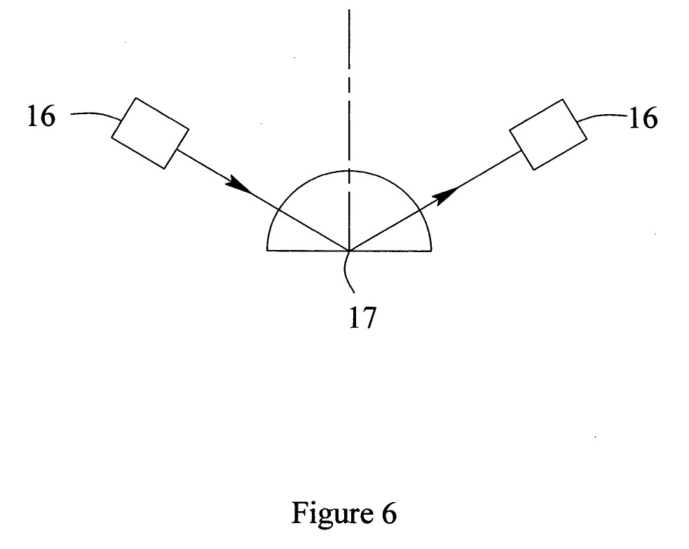

A unipoint multipass configuration that employs a hemispherical ATR element is shown in FIGS. 5 and 6. The optical beam is focused into the center 17 of a hemispherical ATR element 15 at an angle of incidence appropriate for ATR spectroscopy. The angle of incidence is defined as the angle between the normal to the reflecting surface and the incident light. A number of optical reimaging elements 16 are arranged around the hemisphere in a conical arrangement. The axis of the cone is perpendicular to, and centered on the base of the hemisphere. The sample is pressed into contact with the flat face of the hemisphere so that light internally reflects at the sample-hemisphere interface. If the sample absorbs light, the intensity of the reflected light will be attenuated. The reflected light is captured by one of the optical reimaging elements 16 and refocused back to the center of the hemisphere, where it internally reflects, is recaptured and refocused by another element 16, and so on for a number of times. The effect of one reflection is multiplied while always probing the same spot in the center of the hemisphere which is also the common focal point of all the optical reimaging elements 16. This is a significant improvement over the multiple reflection ATR element of the prior art wherein every reflection probes another part of a sample. A small amount of sample placed in contact with the ATR hemisphere can now be analyzed with sensitivity increased in proportion to the number of reflections.

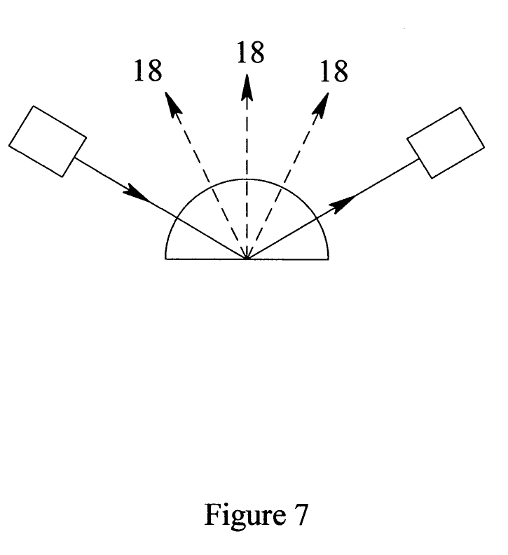

A similar assembly of optical reimaging elements arranged in a conical configuration around the common focal point can be used for Raman or fluorescent spectroscopy. The side view of the arrangement is shown in FIG. 7. Laser light is focused into the center of the ATR hemisphere, where it internally reflects, and is returned a large number of times back to the same point for multiple reflections. Raman or fluorescent radiation 18 from the sample excited by the multiple internally reflecting laser beam, and emitted into the solid angle above the hemisphere, is collected and analyzed by a spectrometer. Again, the weak effect of a single reflection is enhanced by the multiple passes.

While the above description contains many specificities, these should not be construed as limitations on the scope of the invention, but rather as an exemplifications of several preferred embodiments thereof. Many other variations are possible. For example, the larger mirror pair elements accommodating multiple passes could be combined into the multi-element arrangement shown in FIG. 5. Accordingly, the scope of the invention should be determined not by the embodiments illustrated, but by the appended claims and their legal equivalents. We claim:

1. An optical reimaging element comprising two symmetrically opposing confocal and coaxial parabolic reflective surfaces so that any ray of light coming from the common focal point onto one of said surfaces is refocused back to said focal point by the other surface.

2. The optical reimaging element from claim 1 where said element is made by assembling together two identical parabolic mirrors.

3. The optical reimaging element from claim 1 where said optical element is made out of a transparent material by manufacturing said two parabolic surfaces directly into the piece of material and shaping the light entering/exiting surface of the element into a spherical shape with the center of curvature coincident with the focal point of the parabolic surfaces.

4. Two optical reimaging elements from claim 1 arranged on opposite sides of a common focal point with one of said elements slightly rotated around said focal point to provide a multipass configuration, enabling the analysis of a sample placed in said focal point by transmission, Raman or fluorescence spectroscopy.

5. A number of optical reimaging elements from claim 1 arranged around a common focal point in such a way that light reimaged into said focal point by one of said elements enters another creating in such a way a multipass configuration to enable the analysis of a sample placed in said focal point by transmission, Raman or fluorescence spectroscopy.

6. Two optical reimaging elements from claim 3 arranged on opposite sides of a common focal point with one of said elements slightly rotated around said focal point to provide a multipass configuration, enabling the analysis of a sample placed in said focal point by transmission, Raman or fluorescence spectroscopy wherein the reflections on the front surface of the element are recycled back into the measurement while the reflections on the two parabolic surfaces are total internal reflections and therefore lossless.

7. A number of optical reimaging elements from claim 3 arranged around a common focal point in such a way that light reimaged into said focal point by one of said elements enters another creating in such a way a multipass configuration to enable the analysis of a sample placed in said focal point by transmission, Raman or fluorescence spectroscopy wherein the reflections on the front surface of the element are recycled back into the measurement while the reflections on the two parabolic surfaces are total internal reflections and therefore lossless.

8. Two optical reimaging elements from claim 1 where the multipass arrangement is assembled to enable multiple reflections from a reflecting sample placed in the common focal point by inclining the optical elements symmetrically with respect to said reflecting sample whereby light coming to the focus from one said optical element is reflected off said reflecting sample into another said element to enable the analysis of the reflecting sample, placed in said focal point, by reflection, Raman, or fluorescence spectroscopy.

9. A number of optical reimaging elements from claim 1 where the multipass arrangement is assembled to enable multiple reflections from a reflecting sample placed in the common focal point by arranging the optical elements in a conical configuration with said common focal point at the vertex of said cone to enable the analysis of the sample, placed in said focal point, by reflection, Raman or fluorescence spectroscopy.

10. The optical arrangement from claim 8 with a hemispherical internal reflecting element placed centered in the common focal point so that reflections in said focal point are internal reflections, enabling the analysis of a sample, brought in contact with the flat surface of said hemispherical element in said focal point, by internal reflection, Raman or fluorescence spectroscopy.

11. The optical arrangement from claim 9 with a hemispherical internal reflecting element placed centered on the vertex of and coaxial with said cone so that reflections in said focal point are internal reflections, enabling the analysis of a sample, brought in contact with the flat surface of said hemispherical element in said focal point, by internal reflection, Raman or fluorescence spectroscopy.
